(19) United States
(12) Patent Application Publication
(10) Pub. No.: US 2018/0082212 A1
(43) Pub. Date: Mar. 22, 2018

(54) OPTIMIZING MACHINE LEARNING RUNNING TIME

(71) Applicant: Intel Corporation, Santa Clara, CA (US)

(72) Inventors: Lev Faivishevsky, Kfar Saba (IL); Amitai Armon, Tel-Aviv (IL)

(21) Appl. No.: 15/270,057

(22) Filed: Sep. 20, 2016

(51) Int. Cl. G06N 99/00; G06F 15/82

(52) U.S. Cl. CPC G06N 99/005; G06F 15/82

(57) ABSTRACT

An optimization of running time for performing a machine learning algorithm on a processor architecture may be performed and include determining a plurality of parameters to be configured in the machine learning algorithm, and initiating, in the optimization, a plurality of iterations of performance of the machine learning algorithm by the processor architecture. Each of the iterations may include detecting a running time of an immediately preceding one of the iterations, changing a value of one of the parameters used in the immediately preceding iteration to form a new set of values, where the value is changed based on the detected running time of the immediately preceding iteration and according to a downhill simplex algorithm. An optimal set of values for the parameters may be determined based on the plurality of iterations to realize a minimum running time to complete performance of the machine learning algorithm by the processor architecture.

### TECHNICAL FIELD

This disclosure relates in general to the field of computer systems and, more particularly, to machine learning.

### BACKGROUND

Developments in computer science, together with the increasing availability of higher powered computer processing systems have allowed for the development of big data and data analytics applications and systems to flourish. Some systems may utilize machine learning in connection with these analytics. Machine learning programs and their underlying algorithms may be used to devise complex models and algorithms that lend themselves to predictions based on complex (and even very large) data sets. Machine learning solutions have been applied and continue to grow in applications throughout a wide-reaching variety of industrial, commercial, scientific, and educational fields. Deep learning algorithms are a subset of machine learning algorithms that may model high-level abstractions in data through deep graphs (e.g., neural networks) with multiple processing layers, including multiple linear and non-linear transformations. Machine learning may allow computers the “ability” to learn within being explicitly programmed by a user.

### BRIEF DESCRIPTION OF THE DRAWINGS

FIG. 1 illustrates an embodiment of system including an example running time optimization engine.

FIGS. 2A-2B illustrate an examples of processor architectures.

FIG. 3 is a simplified block diagram illustrating an example running time optimization performed using an example optimization engine.

FIG. 4 illustrates a simplified block diagram illustrating a flow of an optimization algorithm used during an example running time optimization.

FIG. 5 are representations of adjustment operations performed in an example optimization algorithm used during an example running time optimization.

FIG. 6 is a flowchart illustrating example techniques for performing a running time optimization for the performance of a particular machine learning algorithm by a particular processor architecture.

FIG. 7 is a block is a block diagram of an exemplary processor in accordance with one embodiment;

FIG. 8 is a block diagram of an exemplary mobile device system in accordance with one embodiment; and

FIG. 9 is a block diagram of an exemplary computing system in accordance with one embodiment.

Like reference numbers and designations in the various drawings indicate like elements.

### DETAILED DESCRIPTION OF EXAMPLE EMBODIMENTS

With the ever-growing involvement of computers in modern life, computing systems are being tasked with more or more responsibilities and enabling ever-increasing capabilities, applications, and services. Machine learning has been used to enable many of these features and is anticipated to assist in adding additional intelligence in fields of ecommerce, web services, robotics, power management, security, medicine, among other fields and industries. For instance, machine learning algorithms have been developed that enable computer-automated classification, facial detection, gesture detection, voice detection, language translation, industrial controls, microsystem control, handwriting recognition, customized ecommerce suggestions, search result rankings, among many others and still limitless future machine learning algorithms still to be developed.

Some machine learning algorithms may be computationally demanding, involving complex calculations and/or large multi-dimensional data sets. As computer processing power increases, machine learning algorithms may be performed by larger numbers of computing devices. Still, in many cases, some computing platforms and computer processing architectures (e.g., particular processor chips, platforms, systems on chip, etc.) are considered better equipped to handle machine learning algorithms, or at least specific classes of machine learning algorithms. Indeed, some machine learning algorithms may be developed to be tuned to be performed on certain computing architectures. Such tuning, however, may limit the adoption of the associated machine learning functions, which may not include the computing architecture that corresponds to a particularly-tuned machine learning algorithm. In some cases, it may be impractical to include a particular computing architecture in a particular device or platform. While other computing architectures may be technically capable of performing a particular machine learning algorithm, performance of the machine learning algorithm using these other computing architectures may be slower, more costly, and less efficient.

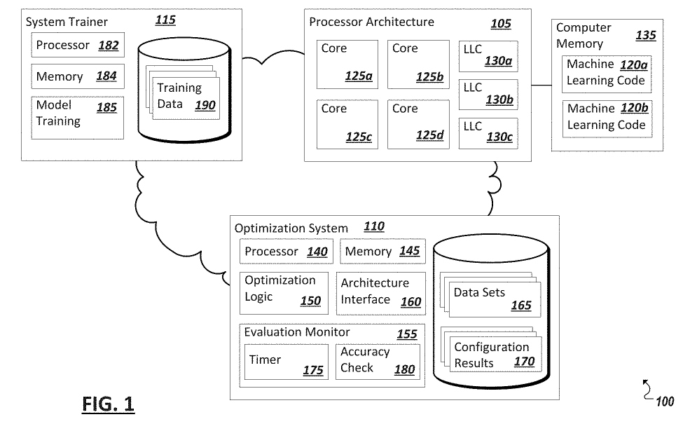

Systems may be provided which resolve at least some of the example issues introduced above. For instance, as shown in the simplified block diagram of FIG. 1, a system 100 may be provided to include a particular computer processor architecture 105 and an optimization system 110 to determine configurations to be applied to various machine learning algorithms to be performed (through execution of code embodying the machine learning algorithm) using the processor architecture 105. In some cases, the optimization system 110 may be provided as a service to determine the optimal configuration parameters to be applied for any one of multiple different processor architectures (e.g., 105). In other cases, the optimization system 110 may be run by the same processor architecture for which it performs the optimization, among other example implementations.

A processor architecture 105 may perform a machine learning algorithm by executing code 120a, 120b embodying the algorithm. Indeed, a processor architecture may access and execute code (e.g., 120a, 120b) for potentially multiple different machine learning algorithms, and may even in some cases, perform multiple algorithms in parallel. Code (e.g., 120a, 120b) embodying a machine learning algorithm may be stored in computer memory 135, which may local or remote to the processor architecture 105. Computer memory 135 may be implemented as one or more of shared memory, system memory, local processor memory, cache memory, etc. and may be embodied as software or firmware (or a combination of software and firmware), among other example implementations.

Processor architectures may assume potentially endless variations and include diverse implementations, such as CPU chips, multi-component motherboards, systems-on-chip, multi-core processors, etc. Within this disclosure, a processor architecture may embody the combination of computing elements utilized on a computing system to perform a particular machine learning algorithm. Such elements may include processor cores (e.g., 125a-d), cache controllers (and corresponding cache (e.g., 130a-c)), interconnect elements (e.g., links, switches, bridges, hubs, etc.) used to the participating computing elements, memory controllers, graphic processing units (GPUs), and so on. Indeed, for a particular system the processor architecture used to perform one algorithm or process may be different from the processor architecture used to perform another algorithm or process. Configuration of the computing system can also dictate, which components are to be considered included in a corresponding processor architecture, such that different systems utilizing the same processor chipset or SOC may effectively have different processor architectures to offer (e.g., one system may dedicate a portion of the processing resources to a background process, restricting access to the full processing resources of the chipset during performance of a particular algorithm, among other potential examples and variants.

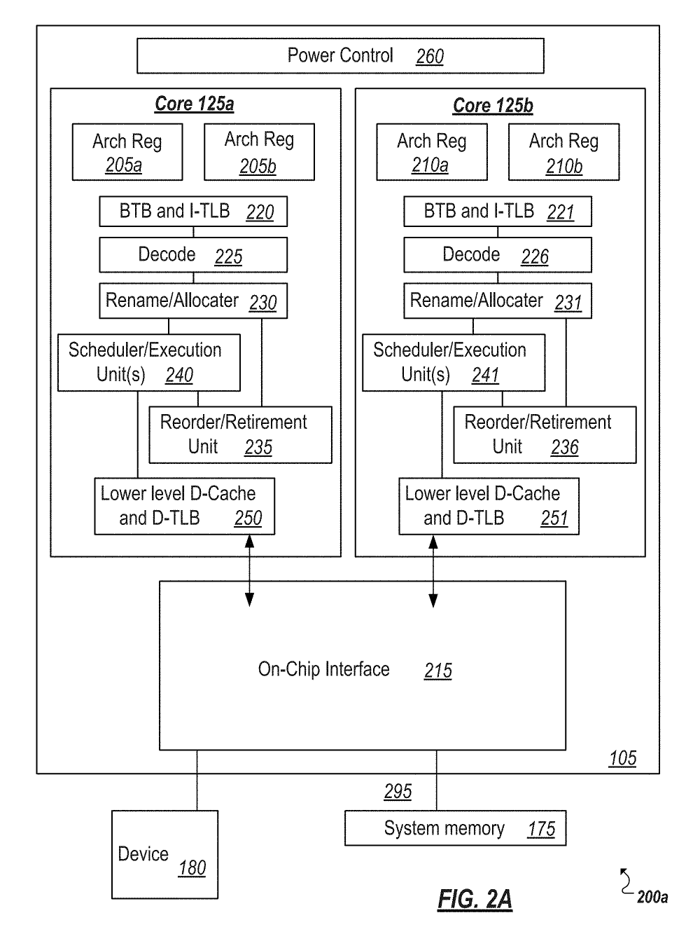

Turning momentarily to FIGS. 2A-2B, simplified block diagrams 200a-b are shown illustrating aspects of example processor architectures. In FIG. 2A, an embodiment of a block diagram for a computing system including a multicore processor architecture is depicted. In FIG. 2A, an embodiment of a purely exemplary processor architecture with illustrative logical units/resources of a processor is illustrated. Note that a processor architecture may include, or omit, any of these functional units, as well as include any other known functional units, logic, or firmware not depicted. Processor architecture 105 includes any processor or processing device, such as a microprocessor, an embedded processor, a digital signal processor (DSP), a network processor, a handheld processor, an application processor, a co-processor, a system on a chip (SOC), or other device to execute code. Processor 105, in one embodiment, includes at least two cores—core 225a and 225b, which may include asymmetric cores or symmetric cores (the illustrated embodiment). However, processor architecture 105 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code, such as code of a machine learning algorithm. A core may include logic located on an integrated circuit capable of maintaining an independent architectural state, wherein each independently maintained architectural state is associated with at least some dedicated execution resources. In contrast to cores, a hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

The example processor architecture 105, as illustrated in FIG. 2A, includes two cores—core 225a and 225b. Here, core 225a and 225b can be considered symmetric cores, i.e. cores with the same configurations, functional units, and/or logic. In another embodiment, core 225a includes an out-of-order processor core, while core 225b includes an in-order processor core. However, cores 225a and 225b may be individually selected from any type of core, such as a native core, a software managed core, a core adapted to execute a native Instruction Set Architecture (ISA), a core adapted to execute a translated Instruction Set Architecture (ISA), a co-designed core, or other known core. In a heterogeneous core environment (i.e. asymmetric cores), some form of translation, such a binary translation, may be utilized to schedule or execute code on one or both cores. A core 225a may include two hardware threads, which may also be referred to as hardware thread slots. A first thread is associated with architecture state registers 205a, a second thread is associated with architecture state registers 205b, a third thread may be associated with architecture state registers 210a, and a fourth thread may be associated with architecture state registers 210b. Here, each of the architecture state registers (205a, 205b, 210a, and 210b) may be referred to as processing elements, thread slots, or thread units, as described above. As illustrated, architecture state registers 205a are replicated in architecture state registers 205b, so individual architecture states/contexts are capable of being stored for logical processor 205a and logical processor 205b. In cores 225a, 225b, other smaller resources, such as instruction pointers and renaming logic in allocator and renamer block 230, 231 may also be replicated for threads 205a and 205b and 210a and 210b, respectively. Some resources, such as re-order buffers in reorder/retirement unit 235, 236, ILTB 220, 221, load/store buffers, and queues may be shared through partitioning. Other resources, such as general purpose internal registers, page-table base register(s), low-level data-cache and data-TLB 250, 251 execution unit(s) 240, 241 and portions of out-of-order unit are potentially fully shared.

The on-chip interface 215 may be utilized is to communicate with devices external to processor architecture 105, such as system memory 275, a chipset (often including a memory controller hub to connect to memory 275 and an I/O controller hub to connect peripheral devices), a memory controller hub, a northbridge, or other integrated circuit. And in this scenario, bus 295 may include any known interconnect, such as multi-drop bus, a point-to-point interconnect, a serial interconnect, a parallel bus, a coherent (e.g. cache coherent) bus, a layered protocol architecture, a differential bus, and a GTL bus.

Memory 275 may be dedicated to processor architecture 105 or shared with other devices in a system. Common examples of types of memory 275 include DRAM, SRAM, non-volatile memory (NV memory), and other known storage devices. Note that device 280 may include a graphic accelerator, processor or card coupled to a memory controller hub, data storage coupled to an I/O controller hub, a wireless transceiver, a flash device, an audio controller, a network controller, or other known device.

In some examples, cores 225a and 225b may share access to higher-level or further-out cache, such as a second level cache associated with on-chip interface 215. Note that higher-level or further-out refers to cache levels increasing or getting further way from the execution unit(s). In one embodiment, higher-level cache is a last-level data cache—last cache in the memory hierarchy on processor architecture 105—such as a second or third level data cache. However, higher level cache is not so limited, as it may be associated with or include an instruction cache.

Recently however, as more logic and devices are being integrated on a single die, such as SOC, each of these devices may be incorporated in processor architecture 105. For example in one embodiment, a memory controller hub is on the same package and/or die with processor architecture 105. Here, a portion of the core (an on-core portion) 215 includes one or more controller(s) for interfacing with other devices such as memory 275 or a graphics device 280. The configuration including an interconnect and controllers for interfacing with such devices is often referred to as an on-core (or un-core configuration). As an example, on-chip interface 215 includes a ring interconnect for on-chip communication and a high-speed serial point-to-point link 295 for off-chip communication. For instance, FIG. 2B illustrates an example of a multi-ring interconnect architecture utilized to interconnect cores (e.g., 125a, 125b, etc.), cache controllers (e.g., 290a, 290b, etc.), and other components in an example processor architecture. In other examples, such as processor architectures implemented in a SOC environment, even more devices, such as the network interface, co-processors, memory 275, graphics processor 280, and any other known computer devices/interface may be integrated on a single die or integrated circuit to provide small form factor with high functionality and low power consumption.

Returning to the discussion of FIG. 1, machine learning algorithms (e.g., embodied in code 120a, 120b) may be deep learning algorithms (or deep structured learning, hierarchical learning or deep machine learning algorithms), such as algorithms based on deep neural networks, convolutional deep neural networks, deep belief networks, recurrent neural networks, etc. Deep leaning algorithms may be utilized in an ever-increasing variety of applications including speech recognition, image recognition, natural language processing, drug discovery, bioinformatics, social media, ecommerce and media recommendation systems, customer relationship management (CRM) systems, among other examples. The performance of a deep learning algorithm may be typified by the training of a model or network (e.g., of artificial “neurons”) to adapt the model to operate and return a prediction in response to a set of one or more inputs. In many cases, the training of a deep leaning algorithm can be a lengthy and costly process. Proper training can allow the deep learning model to arrive at a reliable conclusion for a variety of data sets. Training may be continuous, such that training continues based on “live” data received and processed using the deep learning algorithm following training on a training data set (e.g., 190). Such continuous training may include error correction training or other incremental training (which may be algorithm specific). Further, training, and in particular continuous training, may be wholly unsupervised, partially supervised, or supervised. A system trainer 115 may be provided (and include one or more processors 184, one or more memory elements 184, and other components to implement model training logic 185) to facilitate or otherwise support training of a deep learning model. In some cases, training logic may be wholly internal to the deep learning algorithm itself with no assistance needed from a system trainer 115. In some cases, the system trainer 115 may merely provide training data 190 for use during initial training of the deep learning algorithm, among other examples.

In one example implementations, an optimization system 110 may include one or more processor devices (e.g., 140) one or more memory elements (e.g., 145) to implement optimization logic 150 and other components of the optimization system 110. In cases where the optimization system (and even the system trainer 115) are implemented on the same system as processor architecture 105, the processors (e.g., 140, 182) and memory elements (e.g., 145, 184) may simply be the processors (e.g., 125a-d) and memory elements (e.g., 130a-c, 135, etc.) associated with the processor architecture 105 itself. In one example, the optimization system 110 may include optimization logic 150 to test a specific deep leaning algorithm (or other machine learning algorithm) using a specific processor architectures to determine an optimized set of configuration parameters to be used in performance of the machine learning algorithm by the tested processor architectures. Configuration parameters, within the context of a machine learning algorithm may include those parameters of the underlying models of the algorithm, which cannot be learned from the training data. Instead, configuration parameters are to be defined for the machine learning algorithm and may pertain to higher level aspects of the model such as parameters relating to and driving the algorithm's complexity, ability to learn, and other aspects of its operations. Such configuration parameter may in turn affect the computation workload that is to be handled by a processor architecture.

The optimization logic 150, in some implementations, may utilize a direct-search-based algorithm, such as a Nelder-Mead, or “downhill simplex”, based multivariate optimization algorithm, to determine optimized configuration parameters for a particular machine learning algorithm for a particular processor architecture. The optimization logic 150, to determine such optimization, may drive the processor architecture to cause the processor architecture to perform the machine learning algorithm (e.g., a deep learning algorithm) a number of time, each time with a different set of configuration parameters tuned according to the direct-search algorithm. In cases where a deep learning algorithm is tested against a particular processor architecture, each iterative performance of the deep learning algorithm by the particular processor architecture (e.g., 105), as directed by the optimization logic 150 (e.g., through an interface 160 (e.g., an API or instruction) to the processor architecture) may itself include multiple iterative tasks as defined within the deep learning algorithm to arrive a sufficiently accurate result or prediction. In some implementations, the testing of a deep learning algorithm against a particular processor architecture (e.g., 105) may involve the use of a data set 165 to be provided as an abbreviated training data set for use as the input to the deep learning algorithm during each performance of the deep learning algorithm during the testing. For each set of configuration parameters selected by the optimization logic to be applied in the deep learning algorithm during processing of the data set 165, an evaluation monitor 155 may evaluate the performance of the deep learning algorithm to determine (e.g., using accuracy check 180) whether a target accuracy is attained by the deep learning algorithm (e.g., from training against the provided abbreviated data set 165). The evaluation monitor 155 may additional include a timer 175 to determine a time (e.g., measured in days/hours/mins/secs, clock cycles, unit intervals, or some other unit of measure) the time taken by the deep learning algorithm to reach the target accuracy by training against the provided data set 165. The optimization system 110 may take the results obtained through the monitoring of a particular performance of the deep learning algorithm by the processor architecture 105 and determine a next iteration of the performance of the algorithm by adjusting at least one configuration parameter value and iteratively re-running the performance of the deep learning algorithm at the processor architecture to determine a set of configuration parameters values that minimizes the running time of the processor architecture to complete its performance of the deep learning algorithm (e.g., to arrive at a targeted level of accuracy in the resulting deep learning model obtained through the performance of the deep learning algorithm).

In general, “systems,” “architectures”, “computing devices,” “servers,” “clients,” “network elements,” “hosts,” “system-type system entities,” “user devices,” “sensor devices,” and “machines” in example computing environment 100, can include electronic computing devices operable to receive, transmit, process, store, or manage data and information associated with the computing environment 100. As used in this document, the term “computer,” “processor,” “processor device,” “processor architecture,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

In some implementations, one or more of the components (e.g., 105, 110, 115, 135) of the system 100 may be connected via one or more local or wide area network connections. Network connections utilized to facilitate a single processor architecture may themselves be considered part of the processor architecture. A variety of networking and interconnect technologies may be employed in some embodiments, including wireless and wireline technologies, without departing from the subject matter and principles described herein.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

As introduced above, in one implementation, a system is provided with a machine learning optimization engine executable to test a particular computing architecture to determine a set of configuration parameter values for a particular machine learning algorithm to be performed by the computing architecture, that minimizes the running time of the particular computing architecture to perform an evaluation using the particular machine learning algorithm. Some machine learning algorithms may be computationally intense and may process very large data sets during an evaluation. Modern machine learning algorithms may include a set of configuration parameters. At least some of the values of these parameters may be adjusted to influence the accuracy and the running time of the algorithm on a particular computational architecture. Configuration parameters may include such examples as values corresponding to a number of leave or depth of a tree structure defined in the machine learning algorithm, a number of latent factors in a matrix factorization, learning rate, number of hidden layers in a deep neural network (DNN), number of clusters in a k-means clustering, mini-batch, among other examples. Traditionally, configuration parameters of a machine learning algorithm are pre-tuned specifically for a single computing architecture or product embodying the computing architecture. For example, a modern deep learning algorithm may be pre-defined with configuration parameters optimized for running on a specific graphics processing unit (GPU) card produced by a specific vendor. However, if these same configuration parameters are set in the machine learning algorithm when performed by a different processor architecture, markedly different (e.g., worse) performance may be observed.

Further, optimization of the machine learning algorithms is typically focused on achieving best accuracy for the algorithm and does not account for the effect on running time to perform the machine learning algorithm to that level of accuracy. For instance, traditional parameter optimization may utilize techniques such as Sequential Model-Based Global Optimization (SMBO), Tree-structured Parzen Estimator Approach (TPE), Random Search for Hyper-Parameter Optimization in Deep Belief Networks (DBN), and others, however, these approaches are designed to optimize the accuracy of a machine learning algorithm without regard to the running time needed to achieve such accuracy.

An improved system may be provided that can facilitate the speeding up of machine learning algorithms and training of the same on any specific processor architecture by determining an optimal set of configuration parameters to be set in the machine learning algorithm when performed by that specific processor architecture. The system, for instance through an optimization engine, may utilize a direct-search-based technique to automatically assign and adjust values of the configuration parameters (i.e., without assistance of a human user) so that the running time of the machine algorithm will be as low as possible while maintaining a target level of accuracy for the machine learning algorithm.

In on example, an optimization engine may be provided that determines, through multivariate optimization, an assignment of configuration parameter values of a machine learning algorithm to be applied when performed by a particular processor architecture to realize a minimal running time for performance of the machine learning algorithm. A set of configuration parameters may be identified in a corresponding machine learning algorithm that are to be considered the variables of a target minimization function defining the minimal running time of the machine learning algorithm to achieve a fixed value of accuracy when such configuration parameter values are applied.

While other optimization techniques for minimizing a function of several variables adopt a gradient-based iterative approach in which an initial set of parameters is updated in each step with better values (with the values are calculated based on the gradient of the target function), the gradient itself has to be evaluated analytically or through numerical approximations of partial derivatives of the target function. However, in the field of algorithm parameter optimization, the gradient of the target function (which is the running time of the algorithm) cannot be evaluated analytically. Accordingly, in order to apply gradient-based optimization techniques, the gradient of the target function is estimated by means of numerical approximations to partial derivatives. Such approximations are to be constructed for each parameter, leaving values of all other parameters fixed. The approximation is obtained by perturbing the parameter value, i.e. increasing and diminishing it by a small amount, and evaluating the target function at the obtained points. The derivative is then computed as a ratio of difference between the two values of the target function divided on twice the perturbation amount. Such techniques, however, are ill-suited to addressing running time minimization, because the running time itself is the target function. By perturbing a value of a parameter in both directions, the target function for the worse of value parameter must be calculated significant amount of times, thereby negatively affecting the running time to perform the optimization determination itself. Accordingly, in some implementations, an improved optimization engine may utilize gradient-free numerical optimization s of the target function.

In one example implementations, an optimization engine may apply Downhill Simplex-based optimization for the multivariate optimization of running time for a particular machine learning algorithm to be performed on a particular processor architecture. Logic implementing a Downhill Simplex-based optimization scheme may utilize an iterative approach, which keeps track of n+1 points in n dimensions, where n is the number of configuration parameters to be set for the machine learning algorithm. These points are considered as vertices of a simplex (e.g., a triangle in 2D, a tetrahedron in 3D, etc.) determined from the set of configuration parameter values. At each iteration, a vertex of the determined simplex determined to have the worst value of the target function is updated in accordance with a Downhill Simplex-based algorithm, to iteratively attempt to adjust the configuration parameters to realize an optimum running time of the machine learning algorithm to realize a target accuracy value.

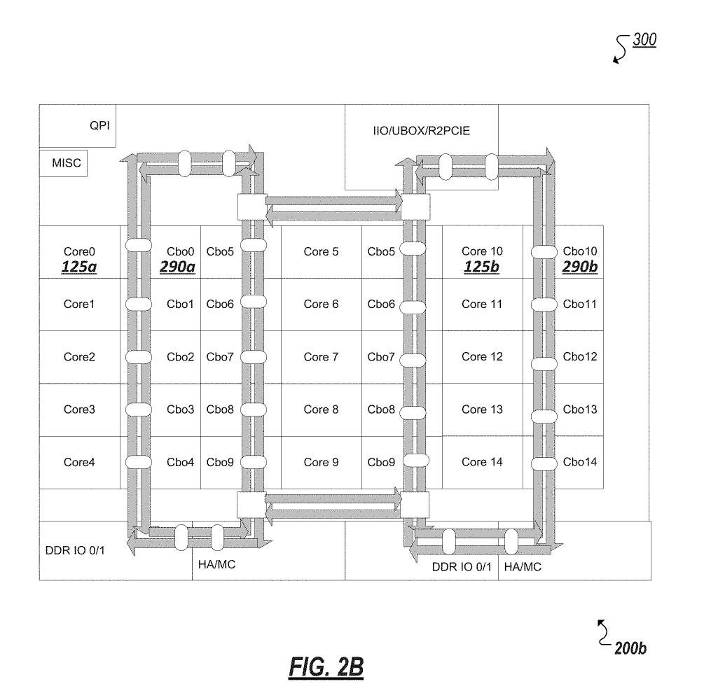

Turning to FIG. 3, a simplified block diagram 300 is shown illustrating an example technique for determining optimized configuration parameter values for a particular deep learning algorithm 120 for use when the particular deep learning algorithm 120 is performed by a particular processor architecture 105. Code executable to perform the deep learning algorithm 120 may be loaded 305 into memory of (or otherwise accessible) to the processor architecture 105. An optimization engine 110 may be provided to drive iterations of the performance of the deep learning algorithm 120. The optimization engine 110 can identify a particular deep learning algorithm 120 to be run on the processor architecture. The optimization engine 110 can further identify a set of two or more configuration parameters of the deep learning algorithm 120. In some cases, only a subset of the potentially configuration parameters are to be selected (e.g., using the optimization engine 110) for the optimization. For instance, while a particular one of the configurable parameters of a deep learning algorithm may be technically configurable, the optimizer may identify that, for a particular processor architecture, some of the parameters may need to be fixed. For instance, some parameters may correspond to a buffer size, the number of cores, another fixed characteristic of a processor architecture. In some implementations, the optimization engine may identify the particular processor architecture and determine which of the configuration parameters are to be treated as variables during optimization. In other cases, a user (e.g., through a graphical user interface (GUI) of the optimization engine 110) may select the subset of configuration parameters to treat as variables, among other examples.

The optimization engine 110 may additionally be used to set a target or boundary for the accuracy to be achieved through performance of the machine learning algorithm 120 during the optimization process. The optimization engine 110 may automatically determine a target based on a known acceptable accuracy range for the particular deep learning algorithm 120, or may receive the accuracy target value through a GUI of the optimization engine 110, among other examples. Further, upon determining the set of variables, the optimization engine 110 may determine initial values of the set of two or more variable configuration parameters to define an initial vector 310. The optimization engine 110 may further may determine a simplex from the initial vector 310 and determine a target equation and simplex for determining the minimum running time for the set of configuration parameter values for use in a downhill simplex-based optimization analysis of the performance of the deep learning algorithm 120 by the processor architecture 105.

Performance of the downhill simplex-based optimization analysis by the optimization engine 110 may include the optimization engine assigning the initial parameter values in the machine learning algorithm 120 and, in some cases, providing 320 a data set 320 for use by the machine learning algorithm during each of the performance iterations 325 driven by the optimization engine 110 during the downhill simplex-based optimization analysis. With the initial parameters values set in the machine learning algorithm 120, an initial performance of the deep learning machine language algorithm 120 may be initiated by the optimization engine 110. The machine learning algorithm 120 may be run on the processor architecture 110 to cause the machine learning algorithm to iterate through the provided data set 165 until it reaches the target accuracy. The optimization engine 110 may monitor performance of the machine learning algorithm to identify when the machine learning algorithm reaches the specified accuracy target. The time taken to realize the accuracy target may be considered the preliminary minimum running time for the machine learning algorithm's execution by the processor architecture.

Based on the results of the initial iteration of the performance of the machine learning algorithm, the optimization engine 110 may apply a downhill simplex-based algorithm to determine the value of one of the set of configuration parameter to adjust before re-running the machine learning algorithm on the processor architecture. The optimization engine 110 may continue to drive multiple iterations 325 of the performance of the machine learning algorithm 120 on the processor architecture 105, noting the running time needed to reach the target accuracy value and further adjusting configuration parameters values (one at a time) until a set of configuration parameter values is determined, which realizes the lowest running time observed during the iterations 325.

In some cases, in addition to receiving an accuracy target and initial vector, the optimization engine 110 may also receive a maximum iteration value to limit the number of iterations 325 of the performance of the machine learning algorithm triggered by the optimization engine 110 during the optimization process. A maximum iteration value may be utilized to constrain the running time of the optimization process itself. Additional efficiencies may be realized during the optimization process by cancelling any iteration of the performance of the machine learning algorithm, when the measured running time for that particular iteration surpasses the current, lowest running time value determined from previous iterations of the machine learning algorithm. In such instances, the iteration may be terminated (e.g., at the direction of the optimization engine) allowing running time of the optimization process to be shortened by skipping to the next adjustment of the configuration values and immediately initiating the next iteration of the performance of the machine learning algorithm (even when the cancelled iteration never reached the target accuracy).

Upon determining the optimized configuration parameter values for a pairing of the machine learning algorithm and the particular processor architecture 105, the optimization engine 110 may persistently set (at 330) the optimal parameter values as the final parameter values in the machine learning algorithm. Thereafter, any subsequent performance of the machine learning algorithm 120 by the processor architecture 105 will be carried out with the optimal parameter values. This may include the full, formal training of the machine learning algorithm using training data 190 (e.g., provided 335 by a system trainer or other source of training data). This may allow the training of the machine algorithm on the processor architecture to also be optimized in terms of the running time needed to complete the training.

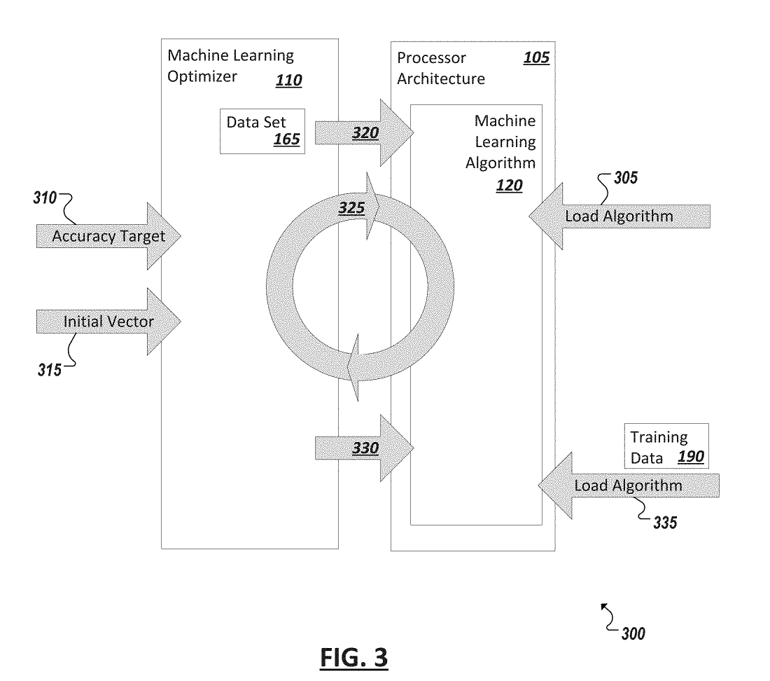

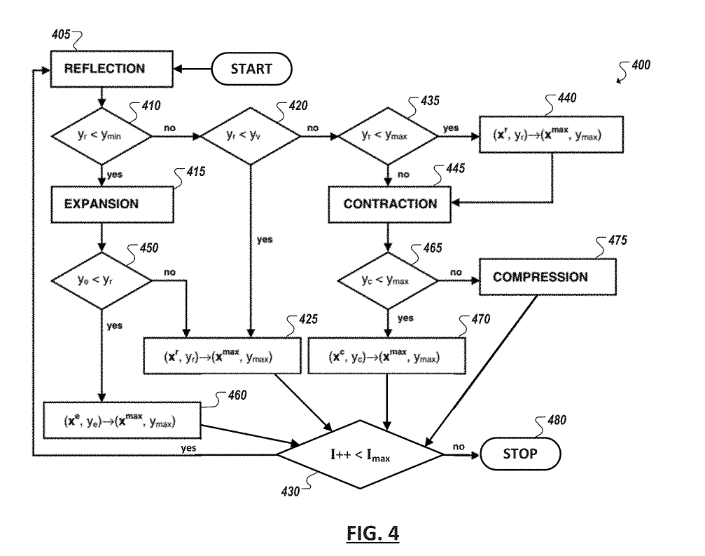

Turning to FIG. 4, a simplified flow diagram 400 is shown illustrating example actions to be performed by an optimization engine in connection with an optimization process to discover a set of configuration parameter values of a particular machine learning algorithm to minimize the running time for a particular processor architecture to perform the particular machine learning algorithm. The optimization process may iteratively adjust values of the configuration parameters according to a downhill simplex algorithm. FIG. 4 illustrates aspects of the flow of an example downhill simplex optimization algorithm. A downhill simplex algorithm may dictate adjustments to a multivariate set through reflection (e.g., 405), expansion (e.g., 415), contraction (e.g., 445), and compression (e.g., 475). FIG. 5 shows representations 500a-f of these techniques.

Given a continuous function y=ƒ(x₁, . . . , x_{N}) of N variables x={x₁, . . . , x_{N}}, where the variables correspond to the configuration parameters of a selected machine learning platform and the function yᵣ, is to determine a local minimum time value corresponding to variables x^{m}. To determine the minimum, a simplex (e.g., 500a) of N+1 points can be constructed with vectors x¹, . . . , x^{N}, x^{N+1}, corresponding to the configuration parameter values to be set for a particular machine learning algorithm. The initial configuration parameter values may be utilized to generate a start simplex, from which its vertices may be sorted (e.g., at 500b) to satisfy yₘᵢₙ< . . . <yᵥ<yₘₐₓ, where yₘᵢₙ (e.g., 505) is the best point, yₘₐₓ is the worst point (e.g., 510), and yᵥ is the second worst point. Further, a mirror center point x^{s} (e.g., 515) may be determined from all points except the worst point, based on which a reflection operation (e.g., 500c) may be performed, according to:

$${x}^{s} = \frac{1}{N} {\sum }_{{x}^{i} \neq {x}^{max}}^{ } {x}^{i}$$

In the example of FIG. 4, to begin the optimization process, the optimization engine may perform a reflection 405 of the worst configuration parameter value point over the mirror center point (e.g., as represented at 500c in FIG. 5) according to:

x^{r}=x^{s}+R(x^{s}−x^{max})

and replace the worst value with the determined x^{r}. The value of x^{r} is then used by the optimization engine to change the corresponding configuration parameter value according to the reflection 405, forming a first set of configuration parameter values from the initial set of configuration parameter values. The optimization engine may then run an iteration of the performance of the machine learning algorithm using the targeted processor architecture to determine a running time yᵣ=ƒ(x^{r}) for the machine learning algorithm with the configuration parameters set to the first set of values (according to x^{r}). Following the iteration, the optimization engine determines (at 410) whether the resulting running time yᵣ for this iteration is better than the running time of yₘᵢₙ. If so, the optimization engine performs an expansion 415 (e.g., represented at 500d in FIG. 5) for the same parameter value changed in the reflection 405. If not, the optimization engine evaluates (at 420) whether the running time yᵣ resulting from the reflection 405 is better than the second worst case yᵥ. If so, the yᵣ is assumed (at 425) to be the best minimum determined thus far during the optimization and x^{r} becomes the starting point of the next iteration of the performance of the machine learning algorithm (replacing xⁱ). If not, then yᵣ is evaluated against yₘₐₓ (at 435) to determine if the reflection 405 resulted in any improvement of the running time. If yes, x^{r} again becomes the starting point of the next iteration (at 440); if no, xⁱ is retained as the starting point of the next iteration, which is to involve a contraction 445 (e.g., represented at 500e in FIG. 5) of the worst value (in either xⁱ or x^{r}).

Continuing with the example of FIG. 4, a contraction 445 may be performed in connection with an optimization algorithm when it is determined that a reflection of the worst value is counterproductive to improving running time. Performing a contraction results in the “worst” parameter value being adjusted in accordance with the contraction to form a new data set x^{c}. This has the effect, for x^{r}, of minimizing the extent of the reflection, and for xⁱ, undoing the reflection and performing a negative reflection over the mirror point (as illustrated at 500e in FIG. 5). A next iteration of the machine learning algorithm may be triggered by the optimization engine to determine the running time y_{c}=ƒ(x^{c}) with the contraction-modified parameter value, to identify whether the contraction improves the running time. The result may be used to identify the worst data point of the starting point (e.g., in xⁱ or x^{r}) and replacing it with a new value in accordance with a contraction 475. Likewise, in the case of an expansion (e.g., 415), the optimization engine may determine a new configuration parameter value (i.e., for the worst value) resulting in a new parameter value set x^{e}, and initiate another performance of the particular machine learning algorithm by the processor architecture using the new value (from the expansion 415) to determine the running time yₑ=ƒ(x^{e}) with the expansion-modified parameter value.

In the case of a contraction 445, upon determining the running time y_{c} from the next iteration, the resulting running time y_{c} may be compared to yₘₐₓ (at 465). If y_{c} is less than yₘₐₓ, then x^{c} can assume the starting point for the next iteration (at 425) according to the downhill simplex algorithm (e.g., with next step being a reflection 405 using x^{c} as the starting point and treating y_{c} as the new yₘₐₓ). If y_{c} is not an improvement over yₘₐₓ, then the optimization engine may perform a compression 475 (represented as 500f in FIG. 5) to compress the simplex toward the best point, where vᵢ=xᵢ+S (xᵢ+x₁), i=2, . . . , n+1. The vertices of the simplex at the next iteration are x₁, v₂, . . . , v_{N+1}. Following the compression 475, the optimization algorithm can cycle back to a reflection based on the newly compressed data set.

In the case of an expansion 415, the corresponding iteration using x^{e} results in the determination of the corresponding running time yₑ for the iteration. If yₑ represents an improvement over yᵣ (at 450), x^{e} may supplant x^{r} and will be adopted as the starting point for the next round of the optimization algorithm (starting with another reflection 405). On the other hand, if yᵣ resulted in a lower running time (than yₑ), x^{r} is retained as the starting point for the next round of the optimization algorithm.

In one implementation, such as illustrated in the example of FIG. 4, a maximum number of iterations of the performance of a machine algorithm in an optimization process may be set at Iₘₐₓ. Accordingly, as the optimization engine evaluates whether to restart the downhill simplex-based optimization algorithm (such as illustrated in the flowchart of FIG. 4), the optimization engine may determine (at 430) whether the next iteration I++ exceeds the maximum number of iterations Iₘₐₓ. If the maximum number of iterations has been reached, the optimization engine may end 480 the evaluation and determine that the current x^{max}, yₘₐₓ represents the optimized combination of parameter values (x^{max}) to realize the lowest observed running time (yₘₐₓ). While additional iterations of the optimization process may yield further improvements and more optimal results, setting the maximum number of iterations at Iₘₐₓ may represent a compromise to manage the running time of the optimization process itself.

If the maximum number of iterations at Iₘₐₓ has not been exceeded (or another alternative end condition has not been met), the optimization process may continue, restarting with an evaluation of the most recently adopted (e.g., at 425, 440, 460, or 470) x^{max} to determine a new worst value in the target function y. The worst value may again be identified and a reflection (e.g., 405) again performed to generate yet another parameter value set from which the optimization engine may trigger an iteration of the machine learning algorithm. Such a flow (e.g., as illustrated in FIG. 4) may continue until an end condition (e.g., 430) is satisfied, causing an optimal configuration parameter value set to be determined and adopted for the machine learning algorithm when run using the tested processor architecture.

For purposes of illustrating principles described herein, a non-limiting practical optimization example is discussed. In this example, a deep learning algorithm is provided for use in text analytics, such as a word embedding algorithm including a set of language modeling and feature learning techniques in natural language processing where words or phrases from the vocabulary are mapped to vectors of real numbers in a low-dimensional space relative to the vocabulary size (“continuous space”). For instance, the example deep learning algorithm may be embodied as shallow, two-layer neural networks that are to be trained to reconstruct linguistic contexts of words. When trained, the example algorithm may be presented with a word as an input and provide a guess as to the words which occurred in adjacent positions in an input text. Further, after training, the resulting deep learning models can be used to map each word to a vector of typically several hundred elements, which represent that word's relation to other words, among other examples.

In the particular illustrative example introduced above, a set of configuration parameters may be identified for the example word embedding algorithm, such as summarized below in Table 1. For instance, eight configuration parameters may be identified, through which values may be adjusted to affect the duration of training time for the example word embedding algorithm.

TABLE 1
Configuration Parameters of an Example Deep Learning Algorithm

| Parameter Name | Meaning |
|---|---|
| Embedding size | The embedding dimension size. |
| | Each word will be represented |
| | as a vector of this size. |
| Initial learning rate | The initial value for learning rate. |
| | Each epoch learning rate |
| | decays linearly. |
| Negative samples per | A small number of opposite |
| training example | examples that is enough to |
| | distinguish right context for the |
| | target from wrong contexts. |
| Numbers of training | The size of minibatch used |
| examples each step | |
| processes | |
| Number of concurrent | The number of threads to be used, |
| training steps | usually equal to the effective |
| | number of cores |
| Number of words to predict | The number of words to predict to |
| per side | the left and right |
| Minimum number of word | The minimum number of word |
| occurrences | occurrences for it to be included |
| | in the vocabulary |
| Subsample threshold for | Threshold at which words appearing |
| word occurrence | with higher frequency will |
| | be randomly down-sampled |

In some implementations, an implementation of a deep learning algorithm, such in the example above, may be provided with default configuration parameter values. In such cases these “current parameters” may be used as a starting point in a running time optimization performed for a particular processor architecture's performance of the deep learning algorithm. The current parameters may also, or alternatively, be used as a benchmark for determining whether the optimization improves upon the default values, among other examples. In some cases, one or more of the default configuration values may be adopted as a fixed configuration value during a particular optimization (even though the parameter value may be technically adjustable). Other rules may be applied during the optimization to set bounds on the values each configuration parameter may have.

Tables 2 and 3 present two examples of an optimization of the example deep learning algorithm discussed above. In the example of Table 2, an embedding size value defined in the current parameters of the example word embedding algorithm is adopted, while other configuration parameter values are identified as configurable within a running time optimization of the word embedding algorithm on a particular processor architecture (e.g., a Xeon™ dual socket 18 core processor). Multiple performances of the word embedding algorithm may be completed at the direction of the optimization engine, with the optimization engine adjusting configuration parameter values iteratively according to a downhill simplex-based algorithm. Table 2 reflects the set of configuration parameter values determined through the optimization to yield the lowest running time for performance of the example word embedding deep learning algorithm on the subject processor architecture. As shown in Table 2, some of the values have changes markedly from the default, “current,” parameters, while other values remain the same. Further, as shown in Table 2, a nearly 3000% improvement in running time performance (as measured by a running time to accuracy ratio) is achieved in this example through the optimization over the running time performance on the subject processor architecture using the default parameters. For instance, while performance of the machine learning algorithm using the determined optimal parameters may yield a lesser accuracy (but still hit a target accuracy range) than with the default parameters, because the example optimization set a target accuracy range, the accuracy achieved through adoption of the optimal parameters may still be considered “accurate enough,” while yielding a dramatic improvement in running time (e.g., an improvement from 276.9 minutes using the default parameters, to a running time of just 8.5 minutes using the optimal parameters).

TABLE 2
Results of (First) Example Optimization

| | Parameter | |
|---|---|---|
| | Current | Optimal |
| | Parameters | Parameters |
| Embedding size | 200 | 200 |
| Initial learn rate | 0.02 | 0.0268 |
| Negative samples per training example | 100 | 24 |
| Number of training examples each | 16 | 520 |
| step processes | | |
| Number of concurrent training steps | 12 | 36 |
| Number of words to predict to the left | 5 | 5 |
| and right | | |
| Minimum number of word occurrences | 5 | 7 |
| Subsample threshold for word occurrence | 0.001 | 0.001012 |

Target

| | | |
|---|---|---|
| Running time to accuracy, minutes | 276.9 | 8.5 |

Similar to Table 2, Table 3 illustrates another example of an optimization, but where the embedding size parameter is held constant at 300 instead of 200. In this example, the running time improvements are less dramatic, with optimization facilitating an optimal parameter set that yields a nearly 800% improvement of the running time when the default parameters are applied when the subject processor architecture performs the example word embedding algorithm.

TABLE 3
Results of (Second) Example Optimization

| | Parameter | |
|---|---|---|
| | Current | Optimal |
| | Parameters | Parameters |
| Embedding size | 300 | 300 |
| Initial learning rate | 0.025 | 0.0269 |
| Negative samples per training example | 25 | 24 |
| Number of training examples each | 500 | 496 |
| step processes | | |
| Number of concurrent training steps | 12 | 36 |
| Number of words to predict to the left | 15 | 5 |
| and right | | |
| Minimum number of word occurrences | 5 | 7 |
| Subsample threshold for word occurrence | 0.001 | 0.001089 |

Target

| | | |
|---|---|---|
| Running time to accuracy, minutes | 80.2 | 14.3 |

As noted above, upon determining a set of optimal parameters for a particular combination of machine learning algorithm and processor architecture, these parameters may be assigned to the machine learning algorithm for all future performances of the machine learning algorithm by the processor architecture. Such subsequent performances of the machine learning algorithm can be in connection with a full training of the machine learning algorithm. As an example, a data set provided for processing by the machine learning algorithm during iterative performances of the algorithm during a running time optimization may be a fraction of the size of a training data set to be used during training of the machine learning algorithm using the processor architecture. For instance, returning to the word embedding deep learning algorithm example above, during optimization, a data set of 17 million words may be used. However, for the full training, the training data set of over a billion words may be used. Using the default parameters, this training may take over a week for a particular processor architecture to complete (potentially making use of the example deep learning algorithm prohibitively burdensome to run using the particular processor architecture). However, from the optimization (e.g., exemplified in Tables 2 and 3), optimal configuration parameters for the deep learning algorithm may be determined, which when also applied during training result in the training being completed in a matter of a few hours. Such improvements allow for a more diverse selection of processor architectures being available to perform deep learning algorithms and serve as a suitable platform in Big Data, large scale data analytics, and other systems.

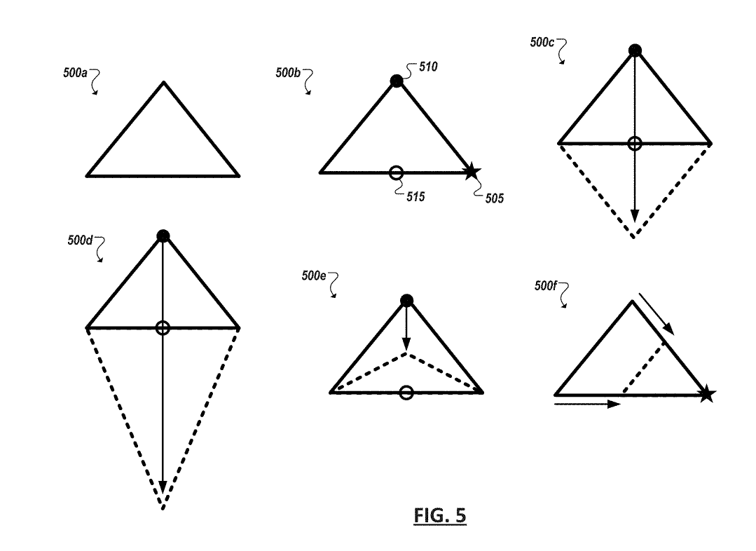

FIG. 6 is a flowchart 600 illustrating example techniques for performing a running time optimization for the performance of a particular machine learning algorithm on a particular processor architecture. A request may be received 605 by an optimization engine. The optimization engine may be executed on a computing platform that includes the subject particular processor architecture or on a computing platform separate and distinct from, but capable of interfacing and communicating with, the platform of the particular processor architecture. In some instances, the request may be a user request. In other instances, the request may be automatically generated, or even self-generated by the particular machine learning algorithm, in response to identifying that the particular machine learning algorithm is to be performed for the first time on a particular processor architecture.

In the optimization, a set of configuration parameters may be determined 610 for the machine learning algorithm. Two or more of the configuration parameters may be selected to be adjusted in connection with the optimization. The optimization parameters may define, at least in part, the scope of the word to be performed by the processor architecture when performing the particular machine learning algorithm. In some cases, the machine learning algorithm is to perform a number of iterative predictions based on an input data set to arrive, or be trained, to a particular level of accuracy. An input data set may be selected for use by the particular machine learning algorithm during the optimization and a target accuracy (or accuracy ceiling) may be determined 615 for the optimization. In some cases, the target accuracy may be determined 615 from a received user input or from an accuracy baseline or range associated with the particular machine learning algorithm or classes of machine learning algorithms similar to the particular machine learning algorithm, among other examples.

The optimization may involve the optimization engine assigning values to the set of determined configuration parameters before each iteration of the performance of the particular machine learning algorithm. Each iteration may be initiated 625 by the optimization engine (e.g., through a command from the optimization engine through an interface of the particular machine learning algorithm or the particular processor architecture). Each iterative performance of the particular machine learning algorithm may involve the particular machine learning algorithm reaching the identified target accuracy set for the optimization procedure. Following the completion of the particular machine learning algorithm, a running time for that particular performance of the particular machine learning algorithm may be detected 630. Based on the detected running time for the performance of the particular machine learning algorithm with an initial set of configuration parameter values, the optimization engine may identify a single one of the configuration parameter values to change based on a downhill simplex algorithm. The optimization engine may change 635 the configuration parameter accordingly and assign this changed value to be applied in a next iteration of the particular machine learning algorithm by the processor architecture.

Between iterations of the performance of the particular machine learning algorithm, the optimization may determine (at 620) whether it is to initiate further. Conditions may be set, such as running time for the optimization, a maximum number of iterations, a target minimum running time for the performance of the particular machine learning algorithm by the particular processor architecture, identification of an end optimization request (e.g., from a system or user), among other examples. If further iterations are to continue the steps 625, 630, 635 may be repeated in a loop, with the changed set of parameter values being applied and the running time of the next iterative performance 625 of the particular machine learning algorithm being detected 630. The optimization engine may evaluate, according to a downhill simplex algorithm, how to change the configuration parameters of the particular machine learning algorithm based on the detected running time and continue to iterate until the optimization determine (at 620) an end of the optimization iterations. From the optimization iterations, the optimization engine may determine 640 an optimal set of values for the configuration parameters, which yielded the shortest observed running time for the particular processor architecture to perform the particular machine learning algorithm. This optimal set of parameters may then be persistently applied 645 to the particular machine learning algorithm for future performance of the particular machine learning algorithm by the particular processor architecture.

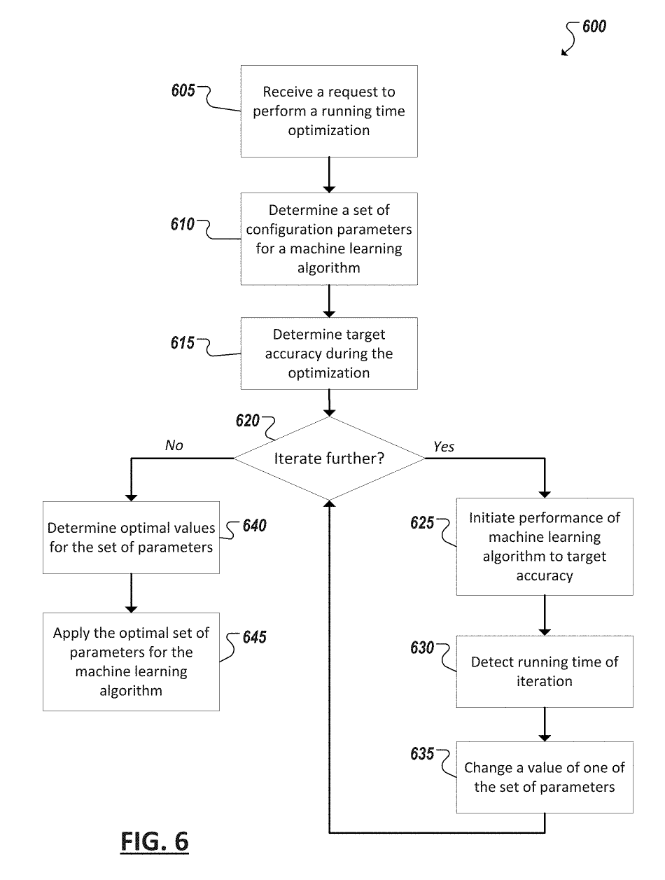

FIGS. 7-9 are block diagrams of exemplary computer architectures that may be used in accordance with embodiments disclosed herein. Other computer architecture designs known in the art for processors, mobile devices, and computing systems may also be used. Generally, suitable computer architectures for embodiments disclosed herein can include, but are not limited to, configurations illustrated in FIGS. 7-9.

FIG. 7 is an example illustration of a processor according to an embodiment. Processor 700 is an example of a type of hardware device that can be used in connection with the implementations above.

Processor 700 may be any type of processor, such as a microprocessor, an embedded processor, a digital signal processor (DSP), a network processor, a multi-core processor, a single core processor, or other device to execute code. Although only one processor 700 is illustrated in FIG. 7, a processing element may alternatively include more than one of processor 700 illustrated in FIG. 7. Processor 700 may be a single-threaded core or, for at least one embodiment, the processor 700 may be multi-threaded in that it may include more than one hardware thread context (or “logical processor”) per core.

FIG. 7 also illustrates a memory 702 coupled to processor 700 in accordance with an embodiment. Memory 702 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Processor 700 can execute any type of instructions associated with algorithms, processes, or operations detailed herein. Generally, processor 700 can transform an element or an article (e.g., data) from one state or thing to another state or thing.

Code 704, which may be one or more instructions to be executed by processor 700, may be stored in memory 702, or may be stored in software, hardware, firmware, or any suitable combination thereof, or in any other internal or external component, device, element, or object where appropriate and based on particular needs. In one example, processor 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor 700 can also include execution logic 714 having a set of execution units 716a, 716b, 716n, etc. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor 700 allows out of order execution but requires in order retirement of instructions. Retirement logic 720 may take a variety of known forms (e.g., re-order buffers or the like). In this manner, processor 700 is transformed during execution of code 704, at least in terms of the output generated by the decoder, hardware registers and tables utilized by register renaming logic 710, and any registers (not shown) modified by execution logic 714.

Although not shown in FIG. 7, a processing element may include other elements on a chip with processor 700. For example, a processing element may include memory control logic along with processor 700. The processing element may include I/O control logic and/or may include I/O control logic integrated with memory control logic. The processing element may also include one or more caches. In some embodiments, non-volatile memory (such as flash memory or fuses) may also be included on the chip with processor 700.

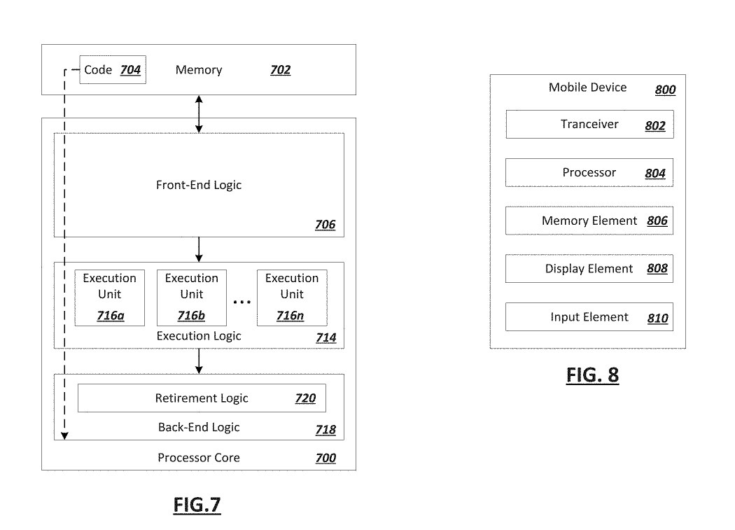

Referring now to FIG. 8, a block diagram is illustrated of an example mobile device 800. Mobile device 800 is an example of a possible computing system (e.g., a host or endpoint device) of the examples and implementations described herein. In an embodiment, mobile device 800 operates as a transmitter and a receiver of wireless communications signals. Specifically, in one example, mobile device 800 may be capable of both transmitting and receiving cellular network voice and data mobile services. Mobile services include such functionality as full Internet access, downloadable and streaming video content, as well as voice telephone communications.

Mobile device 800 may correspond to a conventional wireless or cellular portable telephone, such as a handset that is capable of receiving “3G”, or “third generation” cellular services. In another example, mobile device 800 may be capable of transmitting and receiving “4G” mobile services as well, or any other mobile service.

Examples of devices that can correspond to mobile device 800 include cellular telephone handsets and smartphones, such as those capable of Internet access, email, and instant messaging communications, and portable video receiving and display devices, along with the capability of supporting telephone services. It is contemplated that those skilled in the art having reference to this specification will readily comprehend the nature of modern smartphones and telephone handset devices and systems suitable for implementation of the different aspects of this disclosure as described herein. As such, the architecture of mobile device 800 illustrated in FIG. 8 is presented at a relatively high level. Nevertheless, it is contemplated that modifications and alternatives to this architecture may be made and will be apparent to the reader, such modifications and alternatives contemplated to be within the scope of this description.

In an aspect of this disclosure, mobile device 800 includes a transceiver 802, which is connected to and in communication with an antenna. Transceiver 802 may be a radio frequency transceiver. Also, wireless signals may be transmitted and received via transceiver 802. Transceiver 802 may be constructed, for example, to include analog and digital radio frequency (RF) ‘front end’ functionality, circuitry for converting RF signals to a baseband frequency, via an intermediate frequency (IF) if desired, analog and digital filtering, and other conventional circuitry useful for carrying out wireless communications over modern cellular frequencies, for example, those suited for 3G or 4G communications. Transceiver 802 is connected to a processor 804, which may perform the bulk of the digital signal processing of signals to be communicated and signals received, at the baseband frequency. Processor 804 can provide a graphics interface to a display element 808, for the display of text, graphics, and video to a user, as well as an input element 810 for accepting inputs from users, such as a touchpad, keypad, roller mouse, and other examples. Processor 804 may include an embodiment such as shown and described with reference to processor 700 of FIG. 7.

In an aspect of this disclosure, processor 804 may be a processor that can execute any type of instructions to achieve the functionality and operations as detailed herein. Processor 804 may also be coupled to a memory element 806 for storing information and data used in operations performed using the processor 804. Additional details of an example processor 804 and memory element 806 are subsequently described herein. In an example embodiment, mobile device 800 may be designed with a system-on-a-chip (SoC) architecture, which integrates many or all components of the mobile device into a single chip, in at least some embodiments.

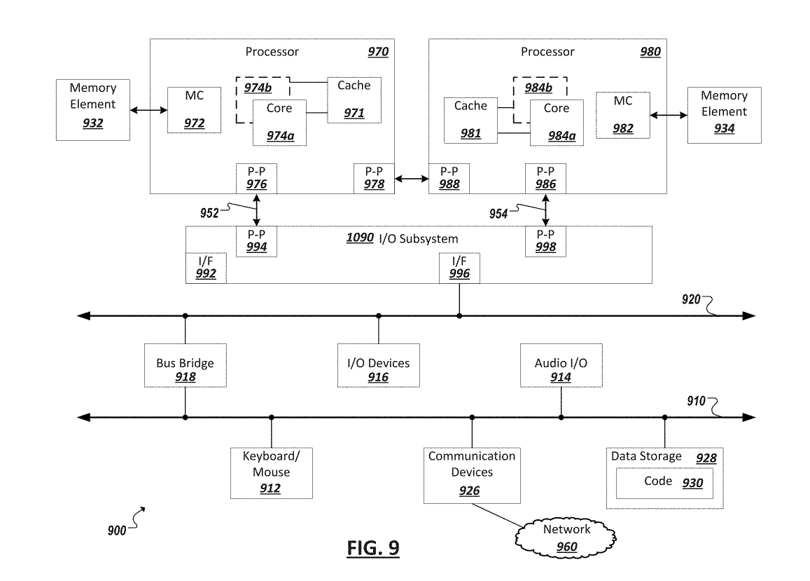

FIG. 9 illustrates a computing system 900 that is arranged in a point-to-point (PtP) configuration according to an embodiment. In particular, FIG. 9 shows a system where processors, memory, and input/output devices are interconnected by a number of point-to-point interfaces. Generally, one or more of the computing architectures and systems described herein may be configured in the same or similar manner as computing system 900.

Processors 970 and 980 may also each include integrated memory controller logic (MC) 972 and 982 to communicate with memory elements 932 and 934. In alternative embodiments, memory controller logic 972 and 982 may be discrete logic separate from processors 970 and 980. Memory elements 932 and/or 934 may store various data to be used by processors 970 and 980 in achieving operations and functionality outlined herein.

Processors 970 and 980 may be any type of processor, such as those discussed in connection with other figures. Processors 970 and 980 may exchange data via a point-to-point (PtP) interface 950 using point-to-point interface circuits 978 and 988, respectively. Processors 970 and 980 may each exchange data with a chipset 990 via individual point-to-point interfaces 952 and 954 using point-to-point interface circuits 976, 986, 994, and 998. Chipset 990 may also exchange data with a high-performance graphics circuit 938 via a high-performance graphics interface 939, using an interface circuit 992, which could be a PtP interface circuit. In alternative embodiments, any or all of the PtP links illustrated in FIG. 9 could be implemented as a multi-drop bus rather than a PtP link.

Chipset 990 may be in communication with a bus 920 via an interface circuit 996. Bus 920 may have one or more devices that communicate over it, such as a bus bridge 918 and I/O devices 916. Via a bus 910, bus bridge 918 may be in communication with other devices such as a keyboard/mouse 912 (or other input devices such as a touch screen, trackball, etc.), communication devices 926 (such as modems, network interface devices, or other types of communication devices that may communicate through a computer network 960), audio I/O devices 914, and/or a data storage device 928. Data storage device 928 may store code 930, which may be executed by processors 970 and/or 980. In alternative embodiments, any portions of the bus architectures could be implemented with one or more PtP links.

The computer system depicted in FIG. 9 is a schematic illustration of an embodiment of a computing system that may be utilized to implement various embodiments discussed herein. It will be appreciated that various components of the system depicted in FIG. 9 may be combined in a system-on-a-chip (SoC) architecture or in any other suitable configuration capable of achieving the functionality and features of examples and implementations provided herein.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. In certain implementations, multitasking and parallel processing may be advantageous. Additionally, other user interface layouts and functionality can be supported. Other variations are within the scope of the following claims.

The following examples pertain to embodiments in accordance with this Specification. One or more embodiments may provide an apparatus, a system, a machine readable storage, a machine readable medium, hardware- and/or software-based logic, and a method to receive a request to perform an optimization to minimize running time by a particular processor architecture in performance of a particular machine learning algorithm, determine a plurality of parameters to be configured in a set of configuration parameters of the particular machine learning algorithm, and initiate, in the optimization, a plurality of iterations of performance of the particular machine learning algorithm by the particular processor architecture. Each of the plurality of iterations may include detecting a running time of an immediately preceding one of the plurality of iterations, changing a value of one of the plurality of parameters used in the immediately preceding iteration to form a new set of values, where the value is changed based on the detected running time of the immediately preceding iteration and according to a downhill simplex algorithm, and determine an optimal set of values for the plurality of parameters based on the plurality of iterations to realize a minimum running time to complete performance of the particular machine learning algorithm by the particular processor architecture, where the minimum running time is observed during the plurality of iterations and the optimal set of values is determined based on the downhill simplex algorithm.

In one example, an initial set of values is determined for the plurality of parameters, and a first performance of the particular machine learning algorithm by the particular processor architecture in the plurality of iterations is initiated with the plurality of parameters set to the initial set of values.

In one example, determining the initial set of values includes randomly generating at least some values in the initial set of values.

In one example, the initial set of values includes a default set of values.

In one example, the optimal set of values is assigned in the particular machine learning algorithm, where the optimal set of values are used in subsequent performances of the particular machine learning algorithm by the particular processor architecture.

In one example, the subsequent performance of the particular machine learning algorithm by the particular processor architecture include training of the particular machine learning algorithm using a training data set.

In one example, the optimization is performed using a particular data set different from the training data set.

In one example, the training data set is larger than the particular data set.

In one example, a request is received to perform a second optimization to minimize running time by a second, different processor architecture in performance of the particular machine learning algorithm, a plurality of parameters is determined to be configured in a set of configuration parameters of the particular machine learning algorithm, a plurality of iterations of performance of the particular machine learning algorithm by the second processor architecture is initiated in the second optimization, a second optimal set of values is determined for the plurality of parameters based on the plurality of iterations in the second optimization, where the second optimal set of values is determined to realize a minimum running time to complete performance of the particular machine learning algorithm by the second processor architecture.

In one example, the optimal set of values includes a first optimal set of values, the first optimal set of values is different from the second optimal set of values, and the minimum running time to complete performance of the particular machine learning algorithm by the second processor architecture is different from the minimum running time to complete performance of the particular machine learning algorithm by the first processor architecture.

In one example, a request is received to perform a second optimization to minimize running time by the particular processor architecture in performance of a second, different machine learning algorithm, a second plurality of parameters is determined to be configured in a second set of configuration parameters of the second machine learning algorithm, a plurality of iterations of performance of the second machine learning algorithm is initiated by the particular processor architecture initiate in the second optimization, and a second optimal set of values is determined for the second plurality of parameters based on the plurality of iterations in the second optimization, where the second optimal set of values is determined to realize a minimum running time to complete performance of the second machine learning algorithm by the particular processor architecture.

In one example, a target accuracy is identified to be achieved in each one of the plurality of iterations of the performance of the particular machine learning algorithm, and the running time for each of the plurality of iterations corresponds to a time for the particular machine learning algorithm to reach the target accuracy.

In one example, identifying the target accuracy includes receiving the target accuracy as an input from a user in connection with launch of the optimization.

In one example, each performance of the particular machine learning algorithm in the plurality of iterations is monitored to detect, in a particular one of the plurality of iterations, that running time for the particular iteration exceeds a previously identified minimum running time for another one of the plurality of iterations prior to the particular iteration reaching the target accuracy, and performance of the particular machine learning algorithm by the particular processor architecture during the particular iteration is terminated based on detecting that the previously identified minimum running time has been exceeded.

In one example, a maximum number of iterations is identified for the optimization, the plurality of iterations includes the maximum number of iterations, and the optimal set of values is to be determined upon reaching the maximum number of iterations.

In one example, the plurality of parameters includes a subset of the set of configuration parameters.

In one example, the plurality of parameters includes the set of configuration parameters.

In one example, the value of one of the plurality of parameters used in the immediately preceding iteration is changes according to one of a reflection, expansion, contraction, or compression.

In one example, the particular machine learning algorithm includes a deep learning algorithm.

In one example, performance of the particular machine learning algorithm includes a plurality of iterative operations using a data set provided in connection with the optimization.

In one example, a simplex is defined corresponding to the plurality of parameters.

In one example, the particular processor architecture includes a remotely located system.

One or more additional embodiments may apply to the preceding examples, including an apparatus, a system, a machine readable storage, a machine readable medium, hardware- and/or software-based logic, and a method to receive a request to determine an optimization of performance of a particular machine learning algorithm by a particular computing architecture including one or more processor cores, determine a plurality of parameters to be configured in a set of configuration parameters of the particular machine learning algorithm, determine an initial set of values for the plurality of parameters, initiate a first performance of the particular machine learning algorithm by the particular computing architecture with the plurality of parameters set to the initial set of values, detect a first running time to complete the first performance of the particular machine learning algorithm by the particular computing architecture, change one of the initial set of values based on the running time and according to a downhill simplex algorithm, where changing the initial set of values results in a second set of values, initiate a second performance of the particular machine learning algorithm by the particular computing architecture with the plurality of parameters set to the second set of values, detect a second running time to complete the second performance of the particular machine learning algorithm by the particular computing architecture, initiate a final performance of the particular machine learning algorithm by the particular computing architecture with the plurality of parameters set to another set of values, detect another running time to complete the final performance of the particular machine learning algorithm by the particular computing architecture, and determining an optimal set of values for the plurality of parameters to realize a minimum running time to complete performance of the particular machine learning algorithm by the particular computing architecture based at least on the other running time and the downhill simplex algorithm.

One or more embodiments may provide a system including, a processor, a memory element, an interface to couple an optimization engine to a particular processor architecture, and the optimization engine. The optimization engine may be executable by the processor to receive a request to perform an optimization to minimize running time by a particular processor architecture in performance of a particular machine learning algorithm, determine a plurality of parameters to be configured in a set of configuration parameters of the particular machine learning algorithm, and initiate, in the optimization, a plurality of iterations of performance of the particular machine learning algorithm by the particular processor architecture. Each of the plurality of iterations may include detecting a running time of an immediately preceding one of the plurality of iterations, changing a value of one of the plurality of parameters used in the immediately preceding iteration to form a new set of values, where the value is changed based on the detected running time of the immediately preceding iteration and according to a downhill simplex algorithm, and determine an optimal set of values for the plurality of parameters based on the plurality of iterations to realize a minimum running time to complete performance of the particular machine learning algorithm by the particular processor architecture, where the minimum running time is observed during the plurality of iterations and the optimal set of values is determined based on the downhill simplex algorithm.

In one example, the optimization engine is further to set, through the interface, the optimal set of values for the plurality of parameters for subsequent performances of the particular machine learning algorithm by the particular processor architecture.

In one example, the processor includes the particular processor architecture.

In one example, the particular processor architecture is remote from the optimization engine.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. At least one machine accessible storage medium having code stored thereon, the code when executed on a machine, causes the machine to:
receive a request to perform an optimization to minimize running time by a particular processor architecture in performance of a particular machine learning algorithm;
determine a plurality of parameters to be configured in a set of configuration parameters of the particular machine learning algorithm;
initiate, in the optimization, a plurality of iterations of performance of the particular machine learning algorithm by the particular processor architecture, wherein each of the plurality of iterations comprises:
detecting a running time of an immediately preceding one of the plurality of iterations;
changing a value of one of the plurality of parameters used in the immediately preceding iteration to form a new set of values, wherein the value is changed based on the detected running time of the immediately preceding iteration and according to a downhill simplex algorithm; and
determine an optimal set of values for the plurality of parameters based on the plurality of iterations to realize a minimum running time to complete performance of the particular machine learning algorithm by the particular processor architecture, wherein the minimum running time is observed during the plurality of iterations and the optimal set of values is determined based on the downhill simplex algorithm.

2. The storage medium of claim 1, wherein the code is further executable to:
determine an initial set of values for the plurality of parameters; and
initiate a first performance of the particular machine learning algorithm by the particular processor architecture in the plurality of iterations with the plurality of parameters set to the initial set of values.

3. The storage medium of claim 2, wherein determining the initial set of values comprises randomly generating at least some values in the initial set of values.

4. The storage medium of claim 2, wherein the initial set of values comprises a default set of values.

5. The storage medium of claim 1, wherein the code is further executable to assign the optimal set of values in the particular machine learning algorithm, wherein the optimal set of values are used in subsequent performances of the particular machine learning algorithm by the particular processor architecture.

6. The storage medium of claim 5, wherein the subsequent performance of the particular machine learning algorithm by the particular processor architecture comprise training of the particular machine learning algorithm using a training data set.

7. The storage medium of claim 6, wherein the optimization is performed using a particular data set different from the training data set.

8. The storage medium of claim 7, wherein the training data set is larger than the particular data set.

9. The storage medium of claim 1, wherein the code is further executable to identify a target accuracy to be achieved in each one of the plurality of iterations of the performance of the particular machine learning algorithm, and the running time for each of the plurality of iterations corresponds to a time for the particular machine learning algorithm to reach the target accuracy.

10. The storage medium of claim 9, wherein identifying the target accuracy comprises receiving the target accuracy as an input from a user in connection with launch of the optimization.

11. The storage medium of claim 9, wherein the code is further executable to:
monitor each performance of the particular machine learning algorithm in the plurality of iterations;
detect, in a particular one of the plurality of iterations, that running time for the particular iteration exceeds a previously identified minimum running time for another one of the plurality of iterations prior to the particular iteration reaching the target accuracy; and
terminate performance of the particular machine learning algorithm by the particular processor architecture during the particular iteration based on detecting that the previously identified minimum running time has been exceeded.

12. The storage medium of claim 1, wherein the code is further executable to identify a maximum number of iterations for the optimization, the plurality of iterations comprises the maximum number of iterations, and the optimal set of values is to be determined upon reaching the maximum number of iterations.

13. The storage medium of claim 1, wherein changing the value according to a downhill simplex algorithm comprises changing one of the plurality of parameters used in the immediately preceding iteration according to one of a reflection, expansion, contraction, or compression.

14. The storage medium of claim 1, wherein the particular machine learning algorithm comprises a deep learning algorithm.

15. The storage medium of claim 1, wherein the code is further executable to define a simplex corresponding to the plurality of parameters.

16. A method comprising:
receiving a request to determine an optimization of performance of a particular machine learning algorithm by a particular computing architecture comprising one or more processor cores;
determining a plurality of parameters to be configured in a set of configuration parameters of the particular machine learning algorithm;
determining an initial set of values for the plurality of parameters;
initiating a first performance of the particular machine learning algorithm by the particular computing architecture with the plurality of parameters set to the initial set of values;
detecting a first running time to complete the first performance of the particular machine learning algorithm by the particular computing architecture;
changing one of the initial set of values based on the running time and according to a downhill simplex algorithm, wherein changing the initial set of values results in a second set of values;
initiating a second performance of the particular machine learning algorithm by the particular computing architecture with the plurality of parameters set to the second set of values;
detecting a second running time to complete the second performance of the particular machine learning algorithm by the particular computing architecture; and
initiating a final performance of the particular machine learning algorithm by the particular computing architecture with the plurality of parameters set to another set of values;
detecting another running time to complete the final performance of the particular machine learning algorithm by the particular computing architecture; and
determining an optimal set of values for the plurality of parameters to realize a minimum running time to complete performance of the particular machine learning algorithm by the particular computing architecture based at least on the other running time and the downhill simplex algorithm.

17. A system comprising:
a processor;
a memory element;
an interface to couple an optimization engine to a particular processor architecture; and
the optimization engine, executable by the processor to:
receive a request to perform an optimization to minimize running time by the particular processor architecture in performance of a particular machine learning algorithm;
determine a plurality of parameters to be configured in a set of configuration parameters of the particular machine learning algorithm;
initiate through the interface, in the optimization, a plurality of iterations of performance of the particular machine learning algorithm by the particular processor architecture, wherein each of the plurality of iterations comprises:
detecting, through the interface, a running time of an immediately preceding one of the plurality of iterations;
changing, through the interface, a value of one of the plurality of parameters used in the immediately preceding iteration to form a new set of values, wherein the value is changed based on the detected running time of the immediately preceding iteration and according to a downhill simplex algorithm; and
determine an optimal set of values for the plurality of parameters based on the plurality of iterations to realize a minimum running time to complete performance of the particular machine learning algorithm by the particular processor architecture, wherein the minimum running time is observed during the plurality of iterations and the optimal set of values is determined based on the downhill simplex algorithm.

18. The system of claim 17, wherein the optimization engine is further to set, through the interface, the optimal set of values for the plurality of parameters for subsequent performances of the particular machine learning algorithm by the particular processor architecture.

19. The system of claim 17, wherein the processor comprises the particular processor architecture.

20. The system of claim 17, wherein the particular processor architecture is remote from the optimization engine.
